(19) United States
(12) Patent Application Publication
(10) Pub. No.: US 2024/0106759 A1
(43) Pub. Date: Mar. 28, 2024

(54) INFORMATION COMMUNICATION APPARATUS, INFORMATION COMMUNICATION METHOD, AND INFORMATION COMMUNICATION PROGRAM

(71) Applicant: NIPPON TELEGRAPH AND TELEPHONE CORPORATION, Tokyo (JP)

(72) Inventors: Takahiro KUBO, Musashino-shi, Tokyo (JP); Shinichi YOSHIHARA, Musashino-shi, Tokyo (JP); Natsuki YASUHARA, Musashino-shi, Tokyo (JP); Go YAZAWA, Musashino-shi, Tokyo (JP)

(73) Assignee: NIPPON TELEGRAPH AND TELEPHONE CORPORATION, Tokyo (JP)

(21) Appl. No.: 18/275,218

(22) PCT Filed: Feb. 16, 2021
(86) PCT No.: PCT/JP2021/005719

§ 371 Date: Aug. 1, 2023

(51) Int. Cl. H04L 47/267; H04L 43/0882; H04L 47/10; H04M 7/00

(52) U.S. Cl. CPC H04L 47/267; H04L 43/0882; H04L 47/18; H04M 7/0072

(57) ABSTRACT

An information communication device arranged between a transmission-side device and a reception-side device according to one embodiment includes a reception unit that receives transmission data to be transmitted from the transmission-side device to the reception-side device, a control unit that receives a notification indicating deterioration in quality the transmission data, determines conversion object data for converting a data type of the transmission data or reducing an information amount of the transmission data and non-conversion object data for not converting a data type based on the notification, and generates post-conversion object data by converting a type of the conversion object data based on the notification, a transmission queue that synthesizes the non-conversion object data and the post-conversion object data and generates converted transmission data, and a transmission unit that transmits the converted transmission data to the reception-side device.

### TECHNICAL FIELD

The present invention relates to an information communication device, an information communication method, and an information communication program.

### BACKGROUND ART

An information communication system promotes smooth communication between users by transmitting various information such as voice, image, and character between user equipment (see, for example, NPL 1). Here, the smooth communication between users means that various information is transmitted from the transmitting user to the receiving user without loss or deformation.

An existing information communication system includes a network quality monitor unit, monitors a congestion state of a transmission line of a network or reception characteristics of a reception-side user equipment, and feeds back the monitor result to the transmission-side user equipment. The user equipment on the transmission-side dynamically switches an encoding technique so as to reduce the information amount of information transmitted by the transmission line to the information amount suitable for the state of the transmission line on the basis of the information on the network quality fed back from the network quality management unit or the user equipment on the reception-side. For example, the user equipment on the transmission-side switches a voice encoding technique for encoding voice data to be transmitted to the user equipment on the reception-side, thereby reducing the information amount of the voice data to be transmitted such switching of the encoding technique, the information amount of information for communicating between users is reduced within a range where the quality of information such as voice can be permitted.

### CITATION LIST

### Non Patent Literature

[NPL 1] Ishibashi, “A technology for realizing a video telephone and a video conference”, Journal of Image Information and Television Engineersa, vol. 59, No. 11, pp. 1627-1632, 2005

### SUMMARY OF INVENTION

### Technical Problem

When the state of the transmission line is remarkably deteriorated in the existing information communication system, even if the encoding technique is switched, information sufficient for users to communicate with each other may not be transmitted from the transmission-side device to the reception-side device.

The present invention has been made by paying attention to the above circumstances, and an object of the present invention is to provide a technique in which, even when a state of a transmission line is remarkably deteriorated in the information communication system, information sufficient for communication between users on a transmission-side and a reception-side from the transmission-side device to the reception-side-device can be transmitted.

### Solution to Problem

In order to solve the above problem, an information communication device arranged between a transmission-side device and a reception-side device according to an aspect of the present invention includes a reception unit that receives transmission data to be transmitted from the transmission-side device to the reception-side device, a control unit that receives a notification indicating deterioration in quality of the transmission data, determines conversion object data for converting a data type of the transmission data or reducing an information amount of the transmission data and non-conversion object data for not converting a data type based on the notification, and generates post-conversion object data by converting a type of the conversion object data based on the notification, a transmission queue that synthesizes the non-conversion object data and the post-conversion object data and generates converted transmission data, and a transmission unit that transmits the converted transmission data to the reception-side device.

### Advantageous Effects of Invention

According to one aspect of the present invention, even when a state of a transmission line is remarkably deteriorated in an information communication system, information sufficient for communication between users on a transmission-side and a reception-side can be transmitted from a transmission-side device to a reception-side device.

### BRIEF DESCRIPTION OF DRAWINGS

FIG. 1 is a block diagram showing an example of a schematic configuration of an information communication system including a code conversion correspondence relay node as a first embodiment of an information communication device of the present invention.

FIG. 2 is a diagram showing an example of a specific configuration of a user equipment.

FIG. 3 is a diagram showing an example of a specific configuration of a congestion monitor type coding control unit of a code conversion correspondence relay node.

FIG. 4 is a block diagram showing an example of a hardware configuration of the user equipment.

FIG. 5 is a diagram showing an example of a hardware configuration of the code conversion correspondence relay node.

FIG. 6 is a flowchart showing an example of a transmission data conversion operation of the code conversion correspondence relay node.

FIG. 7 is a block diagram showing an example of a schematic configuration of an information communication system according to a second embodiment of the present invention.

FIG. 8 is a diagram showing an example of a specific configuration of a user equipment.

FIG. 9 is a diagram showing an example of a specific configuration of a reception characteristic monitor type coding control unit of the code conversion correspondence relay node.

FIG. 10 is a flowchart showing an example of a transmission data conversion operation of the code conversion correspondence relay node.

FIG. 11 is a block diagram showing an example of a schematic configuration of an information communication system according to a modification example of the second embodiment of the present invention.

FIG. 12 is a flowchart showing an example of a transmission data conversion place determination operation of the code conversion correspondence relay node.

### DESCRIPTION OF EMBODIMENTS

Hereinafter, embodiments of the invention will be described with reference to the drawings. Note that, in the following embodiments, parts with the same reference numeral perform the same operation, and their repeated description will be omitted.

### First Embodiment

### (Configuration)

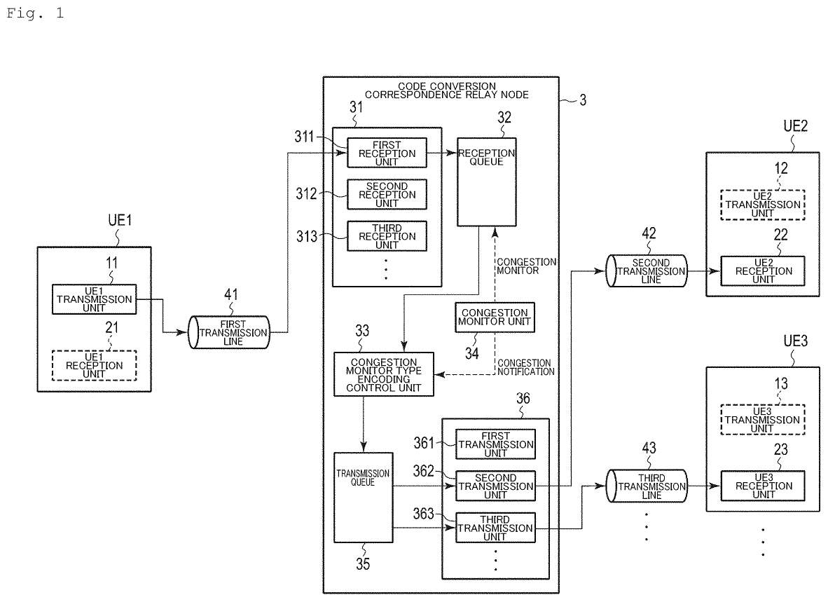

FIG. 1 is a block diagram showing an example of a schematic configuration of an information communication system according to a first embodiment of the present invention.

An information communication system includes a first user equipment UE1 that is a transmission-side device, a second user equipment UE2 that is a reception-side device, a third user equipment UE3 that is a reception-side device, a code conversion correspondence relay node 3 that is an information communication device according to a first embodiment of the present invention, a first transmission line 41, a second transmission line 42, and a third transmission line 43. Hereinafter, the first user equipment UE1, the second user equipment UE2, and the third user equipment UE3 are simply described as user equipment UE if it is not necessary to distinguish them from each other. Further, when the first transmission line 41, the second transmission line 42 and the third transmission line 43 need not be distinguished from each other, the transmission line 4 will be simply described.

In an example shown in FIG. 1, the user equipment UE is connected to the, transmission line 4, and the transmission line 4 is connected to the code conversion correspondence relay node 3 which is an information communication device. That is, the user equipment UE is connected to the code conversion correspondence relay node 3 via the transmission line 4. Then, the user equipment UE is connected to another user equipment UE via the code conversion correspondence relay node 3. In an example of the information communication system shown in FIG. 1, the first user equipment UE1 is connected to the second user equipment UE2 and the third user equipment UE3 via the code conversion correspondence relay node 3, and transmits information to these user equipment UE. Hereinafter, information transmitted from the transmission-side device to the reception-side device is referred to as transmission data. In the example shown in FIG. 1, the first user equipment UE1 as a transmission-side device transmits transmission data to the second user equipment UE2 and the Third user equipment UE3 as reception-side devices, and an information communication system of one-to-many in which one transmitter transmits the transmission data to a plurality of receivers is shown. However, the information communication system according to the present invention can be applied to a one-to-one information communication system in which one transmitter transmits the transmission data to one receiver.

The first user equipment UE1 includes a first user equipment transmission unit 11 (described as “UE1 transmission unit” in FIG. 1) and a first user equipment reception unit 21 (described as “UE1 reception unit” in FIG. 1). Similarly, the second user equipment UE2 includes a second user equipment transmission unit 12 (described as “UE2 transmission unit” in FIG. 1) and a second user equipment reception unit 22 (described as “UE2 reception unit” in FIG. 1), and The third user equipment UE3 includes a third user equipment transmission unit 13 (described as “UE3 transmission unit” in FIG. 1) and a third user equipment reception unit 23 (described as “UE3 reception unit” in FIG. 1). Note that, when it is not necessary to distinguish the first user equipment transmission unit 11, the second user equipment transmission unit 12, and the third user equipment transmission unit 13, the UE transmission unit 1 will be simply described. Similarly, when it is not necessary to distinguish the first user equipment reception unit 21, the second user equipment reception unit 22, and the third user equipment. reception unit 23, the UE reception unit 2 will be simply described. The UE transmission unit 1 appropriately encodes various data received from a user, and transmits the encoded data as transmission data to the UE reception unit 2 which is another user equipment UE via the transmission line 4 and the code conversion correspondence relay node 3. The UE reception unit. 2 appropriately decodes the received transmission data, and outputs to a user in accordance with the decoded information. Thus, the user of the user equipment. UE can transmit various information such as voice data, character data, and image data to the user of the other user equipment UE, thus, smooth communication between users can be performed. Here, the smooth communication between users means that various information is transmitted from the transmission-side user to the reception-side user without loss or deformation.

The code conversion correspondence relay node 3 includes a reception unit 31, a reception queue 32, a congestion monitor type encoding control unit 33, a congestion monitor unit 34, transmission queue 35 and a transmission unit 36.

The reception unit 31 includes a first reception unit 311, a second reception unit 312, and a third reception unit 313. The first reception unit 311, the second reception unit 312, and the third reception unit 313 are configured to receive the transmission data transmitted from the first user equipment transmission unit 11, the second user equipment transmission unit 12, and the third user equipment transmission unit 13. In the example shown in FIG. 1, the first reception unit 311 receives the transmission data transmitted from the first user equipment transmission unit 11 and transmits the data to the reception queue 32. Here, the reception unit may decode the transmission data so that the transmission data can be handled by the congestion monitor type encoding control unit 33. Although FIG. 1 shows an example including three reception units, that is, the first reception unit 311, the second reception unit 312, and the third reception unit 313, four or more reception units may be provided in addition, the first reception unit 311, the second reception unit 312, and the third reception unit 313 may be combined into one reception unit or two reception units. The reception queue 32 stores the transmission data received from each reception unit. The stored transmission data is transmitted to the congestion monitor type encoding control unit 33 for each queue of the user equipment UE having the same destination.

The congestion monitor type encoding control unit 33 selects various information to be transmitted to the user of the user equipment UE on the reception-side included in the received transmission data into conversion object data and non-conversion object data. The congestion monitor type encoding control unit 33 decodes the conversion object data to generate conversion object decoded data. For example, the congestion monitor type encoding control unit 33 decodes the conversion object data to generate voice data as conversion object decoded data. Further, the congestion monitor type encoding control unit 33 converts the type of the conversion object decoded data into the post-conversion object decoded data on the basis of the congestion notification from the congestion monitor unit 34. For example, the congestion monitor type encoding control unit 33 converts voice data into character data or image data, or converts the voice data into voice data whose information amount is reduced. Further, the congestion monitor type encoding control unit 33 performs encoding corresponding to the post-conversion object decoded data to generate post-conversion object data. Then, the congestion monitor type encoding control unit 33 transmits the post-conversion object data and the non-conversion object data to the transmission queue 35.

The congestion monitor unit 34 monitors an occupancy rate with respect to the capacity of the reception queue 32, and monitors a congestion state of the reception queue on the basis of the occupancy rate. Then, when the reception queue occupancy rate exceeds a predetermined threshold value, the congestion monitor unit 34 transmits a congestion notification to the congestion monitor type encoding control unit 33. Here, the reception queue occupancy rate may be a reception queue occupancy rate for each destination or a reception queue occupancy rate of a total of received transmission data. That is, the congestion monitor unit 34 monitors the congestion rate of the transmission data received by the code conversion correspondence relay node 3, and when the congestion rate exceeds the predetermined threshold value, transmits a congestion notification to the congestion monitor type encoding control unit 33.

The transmission queue 35 stores the post-conversion object data and the non-conversion object data, and synthesize the post-conversion object data and the non-conversion object data into one to create converted transmission data. Then, the transmission queue 35 transmits the converted transmission data to the transmission unit 36.

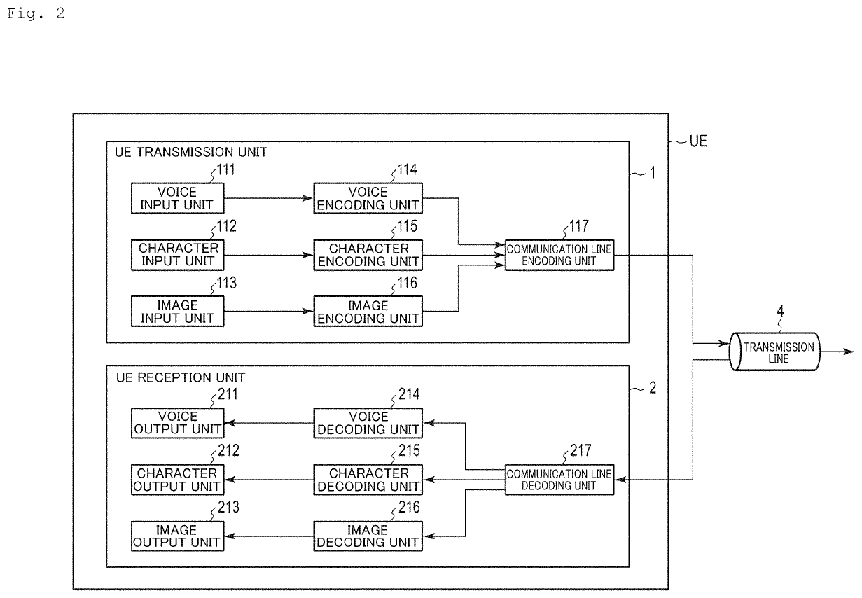

The transmission unit 36 includes a first transmission unit 361, a second transmission unit 362, and a third transmission unit 363. The transmission unit 36 transmits to the user equipment UE from any of the first transmission unit 361, the second transmission unit 362, and the third transmission unit 363 according to the destination of the received converted transmission data. In the example shown in FIG. 1, the second transmission unit 362 and the third transmission unit 363 receive the converted transmission data from the transmission queue, the second transmission unit 362 transmits the converted transmission data to the second user equipment UE2 via the second transmission line 42, and the third transmission unit 363 transmits the converted transmission data to the third user equipment UE3 via the third transmission line 43. Here, the transmission unit 36 may encode the converted transmission data so as to obtain data suitable for the transmission data. FIG. 2 is a diagram showing an example of a specific configuration of the user equipment UE.

A UE transmission unit 1 of user equipment UE includes a voice input unit 111, a character input unit 112, an image input unit 113, a voice encoding unit 114, a character encoding unit 115, an image encoding unit 116, and a communication line encoding unit 117.

The voice input unit 111 receives voice information transmitted from, for example, a control unit (not shown) of the user equipment UE. The voice information may be voice information inputted by a user or the like or voice information stored in the user equipment UE. The character input unit 112 receives the character information transmitted from the control unit. The character information may be character input information inputted by a user or the like or character information stored in the user equipment UE. The image input unit 113 receives the image information transmitted from the control unit. The image information may be image information externally inputted by a user or the like or image information stored in the user equipment UE. Then, the voice input unit 111, the character input unit 112, and the image input unit 113 transmit the received voice information, the character information and the image information are to the voice encoding unit 114, the character encoding unit 115, and the image encoding unit 116, respectively.

The voice encoding unit 114 encodes the received voice information to generate voice encoded data, the character encoding unit 115 encodes the received character information to generate character encoded data, and the image encoding unit 116 encodes the received image information to generate image encoded data. Here, the above encoding may be a general encoding technique, and detailed description thereof will be omitted. The voice encoding unit 114, the character encoding unit 115, and the image encoding unit 116 transmit the generated voice encoded data, the character encoded data, and the image encoded data to a communication line encoding unit 117.

The communication line encoding unit 117 encodes the received data so as to become data suitable for transmission data. Then, the communication line encoding unit 117 transmits the encoded transmission data to the transmission line 4.

A UE reception unit 2 of the user equipment UE includes a voice output unit 211, a character output unit 212, an image output unit 213, a voice decoding unit 214, a character decoding unit 215, an image decoding unit 216, and a communication line decoding unit 217.

The communication line decoding unit 217 receives the converted transmission data transmitted from the other user equipment UE via the transmission line 4. The converted transmission data is data obtained by converting the transmission data by the code conversion correspondence relay node 3, and its details will be described later.

The communication line decoding unit 217 decodes the received converted transmission data. Then, the communication line decoding unit 217 identifies which information of voice encoded data, character encoded data, and image encoded data the decoded data includes. Further, the communication line decoding unit 217 transmits the decoded data to the voice decoding unit 214, the character decoding unit 215, or the image decoding unit 216 according to the identified data. For example, when the received transmission data is identified as voice encoded data, the communication line decoding unit 217 transmits the decoded transmission data to the voice decoding unit 214.

The voice decoding unit 214 decodes the received voice encoded. data to generate voice data, a character decoding unit 215 decodes the received character encoded data to generate character data, an image decoding unit 216 decodes the received image encoded data to generate image data. Here, a decoding may be performed as long as it is a decoding technique corresponding to encoding techniques of the voice encoding unit 114, the character encoding unit 115, and the image encoding unit 116 of the UE transmission unit 1, and detailed description thereof will be omitted. The voice decoding unit 214, the character decoding unit 215, and the image decoding unit 216 respectively transmits generated voice data, character data, and image data to a voice output unit 211, a character output unit 212 and an image output unit 213. The voice output unit 211 outputs the received voice data as voice to the user or the like of the user equipment UE. Similarly, the character output unit 212 and the image output unit 213 display the received character information and image information as characters and images respectively to the user of the user equipment UE.

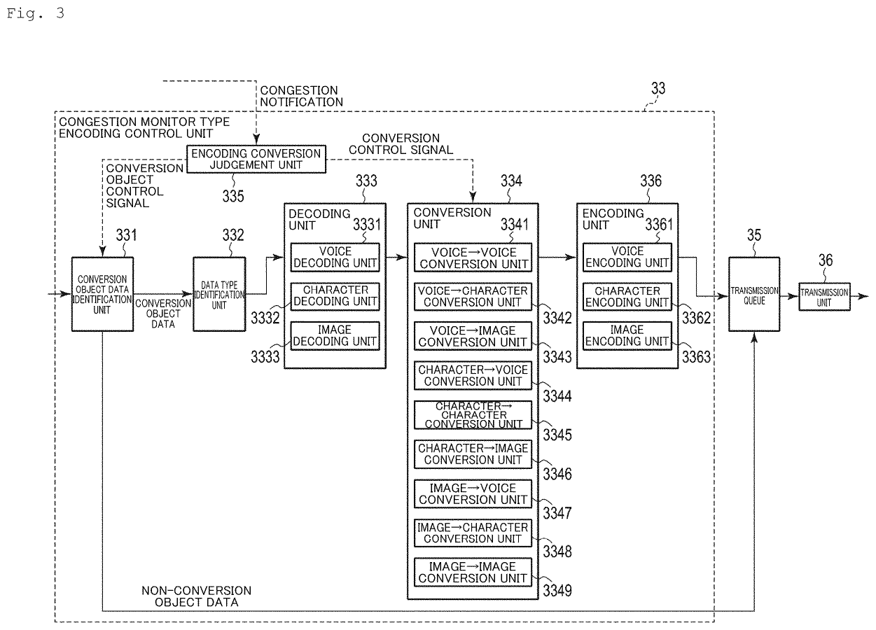

FIG. 3 is a diagram showing an example of a specific configuration of the congestion monitor type encoding control. unit 33 of the code conversion correspondence relay node The congestion monitor type encoding control unit 33 includes a conversion object data identification unit 331, a data type identification unit 332, a decoding unit 333, a conversion unit 334, an encoding conversion judgement unit 335, and an encoding unit 336.

The conversion object data identification unit 331 receives the transmission data transmitted from the reception queue 32. Further, the conversion object data identification unit 331 selects various information to be transmitted to the user of the user equipment UE on the reception-side included in the received transmission data into conversion object data requiring conversion of the data type and non-conversion object data requiring no conversion of the data type. The selection is performed on the basis of the conversion object control signal received from the encoding conversion judgement unit 335. Note that the conversion object control signal will be described later. Here, the conversion object data is data requiring conversion of the data type or reduction of data capacity by the conversion unit 334, and the non-conversion object data is data not requiring conversion of the data type or reduction of data capacity by the conversion unit 334. The conversion object data identification unit 331 transmits the conversion object data to the data type identification unit 332, and transmits the non-conversion object data to the transmission queue 35. Here, the non-conversion object data is temporarily stored in the transmission queue 35 until the conversion of the conversion data is completed. When the conversion object control signal is not received, the conversion object data identification unit 331 transmits the transmission data to a transmission unit 36 via the transmission queue 35 as non-conversion object transmission data, and transmits the non-conversion object transmission data to the transmission line 4.

The data type identification unit 332 identifies which of voice data, character data, and image data the conversion object data is. In the example shown in FIG. 3, the data type identification unit 332 identifies that the conversion object data is voice data. Then, the data type identification unit 332 transmits the identified conversion object data to a decoding unit 333.

The decoding unit 333 includes a voice decoding unit 3331, a character decoding unit 3332, and an image decoding unit 3333. The voice decoding unit 3331 decodes the received conversion object data, and generates voice data as conversion object decoded data. The character decoding unit 3332 decodes the received conversion object data and generates character data as conversion object decoded data. The image decoding unit 3333 decodes the received conversion object data to generate image data as conversion object decoded data. The decoding techniques of the voice decoding unit 3331, the character decoding unit 3332, and the image decoding unit 3333 may be a decoding technique as long as it is used in the voice decoding unit 214, the character decoding unit 215, and the image decoding unit 216 of the user equipment UE. The decoding unit 333 transmits the generated. conversion object decoded data to the conversion unit 334.

The conversion unit 334 includes a voice, voice conversion unit 3341, a voice→character conversion unit 3342, a voice→image conversion unit 3343, a character→voice conversion unit 3344, a character→character conversion unit 3345, a character→image conversion unit 3346, an image→voice conversion unit 3347, an image→character conversion unit 3348, an image→image conversion unit 3349. The conversion unit 334 determines which of the voice→voice conversion unit 3341 or the like is used to convert the conversion object decoded data on the basis of the conversion control signal received from the encoding conversion judgement unit 335. For example, the conversion unit 334 judges how much the amount of data of the conversion object decoded data is to be reduced on the basis of the data type of the conversion object decoded data received from the decoding unit 333 and information on how much the transmission data indicated by the conversion. control signal is congested. Then, the conversion unit 334 determines which of the voice→voice conversion unit 3341 or the like is used to convert the conversion object decoded data on the basis of the judgement. The conversion unit 334 converts the conversion object decoded data by using one of the voice→voice conversion unit 3341 or the like on the basis of the determination. For example, the conversion unit 334 determines to convert voice data, which is conversion able cot decoded data, into character data on the basis of the conversion object control signal. The conversion unit 334 converts voice data, which is conversion object decoded data, into character data by using the voice→character conversion unit 3342. Then, the conversion unit 334 transmits the converted character data to the encoding unit 336 as post-conversion object decoded data. Here, the conversion of the voice data by the voice→voice conversion unit 3341, the conversion of the character data by the character→character conversion unit 3345, and the conversion of the image data by the image→image conversion unit 3349 are performed by voice compression, character compression and image compression and this conversion is a conversion in which the amount of data is reduced. Note that these compression may be performed by using a general compression technique, and detailed description thereof will be omitted. Further, the amount of data may be reduced by a method other than compression. For example, the character→character conversion unit 3345 may reduce the amount of data by creating a summary sentence obtained by summarizing the text of character data.

The voice→character conversion unit 3342 converts, for example, by using a character generation function for recognizing voices and generating characters. This character generation function may be implemented by a general generation technique, and detailed description thereof will be omitted.

The voice→image conversion unit 3343 and the character→image conversion unit 3346 convert by using an image generation function for recognizing voices or characters (sentence) and converting it into pictographs. This image generation function may be implemented by a general generation technique, and detailed description thereof will be omitted.

The character→voice conversion unit 3344 converts, for example, by using a voice generation function for recognizing characters and generating voice. This voice generation. function may be implemented by a general generation technique, and detailed description thereof will be omitted.

The image→voice conversion unit 3347 and the image→character conversion unit 3348 recognize an image of, for example, a monitor camera or the like, and convert the image into a voice or a character of “no abnormality” especially when there is no abnormality and “no change” when there is no change between images before and after.

When the result of the judgement indicates that it is necessary to use a plurality of conversion units, the conversion unit 334 may convert the conversion object data by using a plurality of corresponding units such as voice→voice conversion unit 3341. For example, the conversion unit 334 may convert the voice data into character data and image data by using the voice→character conversion unit 3342 and the voice→image conversion unit 3343.

The encoding conversion judgement unit 335 receives a congestion notification from the congestion monitor unit 34. Then, the encoding conversion judgement unit 335 generates a conversion object control signal and a conversion control signal from the congestion notification. The conversion object control signal is a signal indicating which data among the transmission data is to be converted and which data not to be converted is in the conversion object data identification unit 331, and the conversion control signal is a signal including information indicating how much the transmission data is congested in the reception queue 32. Then, the encoding conversion judgement unit 335 transmits the conversion object control signal to the conversion object data identification unit 331, and transmits the conversion control signal to the conversion unit 334.

The encoding device 336 includes a voice encoding unit 3361, a character encoding unit 3362 and an image encoding unit 3363. For example, the voice encoding unit 3361 encodes voice data which is the post-conversion object decoded data converted by the conversion unit 334, and transmits the encoded voice data to the transmission queue 35. Similarly, the character encoding unit 3362 and the image encoding unit 3363 encode the character data and the image data which are the post-conversion object decoded data converted by the conversion unit 334, respectively, and transmit it to the transmission queue 35. For example, the encoding unit 336 encodes the character data. which is the post-conversion object decoded data converted by using the voice encoding unit 3361. Then, the encoding unit 336 transmits the encoded character data to the transmission queue 35 as the post-conversion object data.

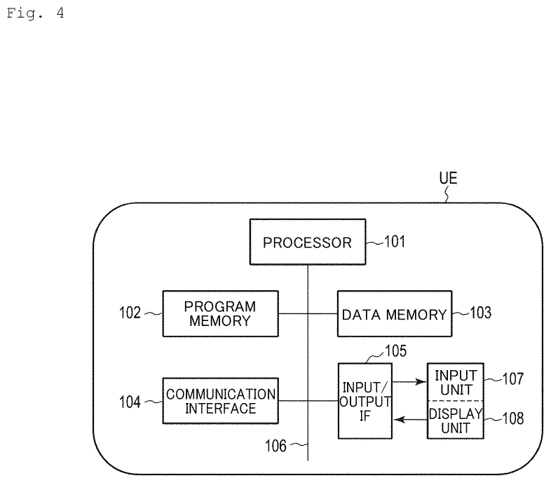

FIG. 4 is a block diagram showing an example of a hardware configuration of the user equipment UE.

The user equipment UE has, for example, a hardware processor 101 such as a CPU (Central Processing Unit) or a MPU (Micro Processing Unit) in addition, a program memory 102, a data memory 103, a communication interface 104, and an input/output interface 105 are connected to the processor 101 via a bus 106. Note that, in FIG. 4, “input/output interface” is abbreviated as “input/output IF”.

As a storage medium, the program memory 102 can use a combination of a nonvolatile memory such as an EPROM (Erasable Programmable Read Only Memory), an HDD (Hard Disk Drive), or an SSD (Solid State Drive) to and from which data can be written and read at any time and a nonvolatile memory such as a ROM (Read Only Memory). In this program memory 102, programs are stored that are required for the processor 101 to execute various types of processing. That is, all of the voice input unit 111, the character input unit 112, the image input unit 113, the voice encoding unit 114, the character encoding unit 115, the image encoding unit 116, the communication line encoding unit 117 of the UE transmission unit 1 of the user equipment UE shown in FIG. 2, and the voice output unit 211, the character output unit 212, the image output unit 213, the voice decoding unit 214, the character decoding unit 215, the image decoding unit 216, and the communication line decoding unit 217 of the UE reception unit 2 of the user equipment UE shown in FIG. 2 may be realized by causing the processor 101 to read and execute the program stored in the program memory 102.

The data memory 103 is a storage that uses, as a storage medium, a combination of, for example, a nonvolatile memory such as an HDD and a memory card to and from which data can be written and read at any time and a volatile memory such as a RAM (Random Access Memory). The data memory 103 is used to store data acquired and generated when the processor 101 executes a program and carries out various types of processing. For example, the data memory 103 can store voice data, character data, and image data received from the user.

The communication interface 104 includes one or more wired or wireless communication modules. For example, the communication interface 104 includes a communication module that wirelessly connects to another user equipment UE via the code conversion correspondence relay node 3. In addition, the communication interface 104 also includes a communication module for wired or wireless connection with a device such as a base station connected to the user equipment UE. Furthermore, the communication interface 104 may include a wireless communication module that wirelessly connects to a Wi-Fi access point, a base station, or the like. That is, the communication interface 104 may be a general communication interface as long as it can communicate with other user equipment UE or device under the control of the processor 101 and transmit and receive various information.

The input unit 107 and the display unit 108 are connected to the input/output interface 105. The input unit 107 is, for example, a device for receiving voice data of a microphone or the like, a device for recognizing character data inputted by the user by an input detection sheet adopting an electrostatic technique or a pressure technique, and a device for receiving image data of a camera or the like. The input unit 107 may be a general device as long as it is a device capable of receiving voice data, character data, image data, etc., Detailed description thereof will be omitted.

The display unit 108 is a display device that uses a. liquid crystal display, an organic EL (Electra Luminescence) display, or the like and displays voices, characters and images that correspond to signals received from the input/output interface 105.

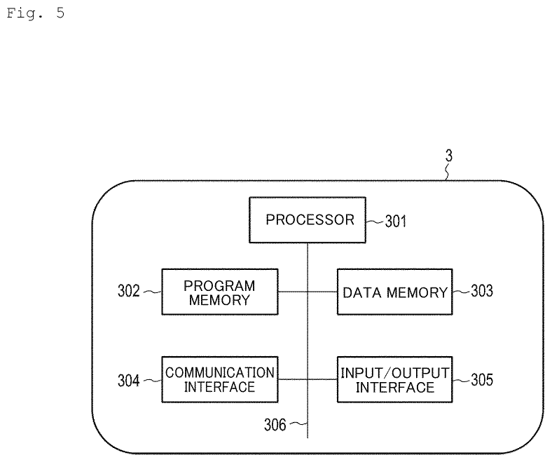

FIG. 5 is a diagram showing an example of a hardware configuration of the code conversion correspondence relay node 3.

As shown in FIG. 5, the code conversion correspondence relay node 3 can be constituted by a computer. The code conversion correspondence relay node 3 has a hardware processor 301 such as a CPU. Then, in the code conversion correspondence relay node 3, a program memory 302, a data memory 303, an input/output interface 305, and a communication interface 304 are connected to the processor 301 via a bus 306.

The program memory 302 uses, as a storage medium, a combination of, for example, a non-volatile memory such as an EPROM, an HDD or an SSD to and from which data can be written and read at any time and a non-volatile memory such as a ROM. Programs necessary for the processor 301 to execute various types of processing according to the embodiment are stored in the program memory 302. That is, all of the reception unit 31, the reception queue 32, the congestion monitor type encoding control unit 33, the congestion monitor unit 34, the transmission queue 35 and the transmission unit 36 of the code conversion correspondence relay node 3 shown in FIG. 1 may be implemented by causing the processor 301 to read and execute the program stored in the program memory 302. Note that some or all of these processing function units may be implemented by other various forms including integrated circuits such as application specific integrated circuits (ASICs) or field-programmable gate arrays (FPGAs).

The data memory 303 is a storage that uses, as a storage medium, a combination of, for example, a nonvolatile memory such as an HDD and a memory card to and from which data can be written and read at any time and a volatile memory such as a RAM (Random Access Memory). This data memory 303 is used to store various types of data obtained and created when various types of processing are performed in other words, regions for storing various types of data are secured as appropriate in the data memory 303 when the various types of processing are performed. For example, the data memory 103 can store the transmission data received from the user, the conversion object data, the non-conversion object data selected from the transmission data, and the like.

The communication interface 304 is an interface which can be connected to the user equipment UE via the communication interface 304. The communication interface 304 may include a general communication module according to a communication medium, a communication method, and a communication protocol of the transmission line 4.

The input/output interface 305 is an interface for exchanging data with a manager who manages the code conversion correspondence relay node 3. The input/output interface 305 may be a general interface as long as it is an interface capable of transmitting and receiving information to and from the manager, and detailed description thereof will be omitted.

### (Operation)

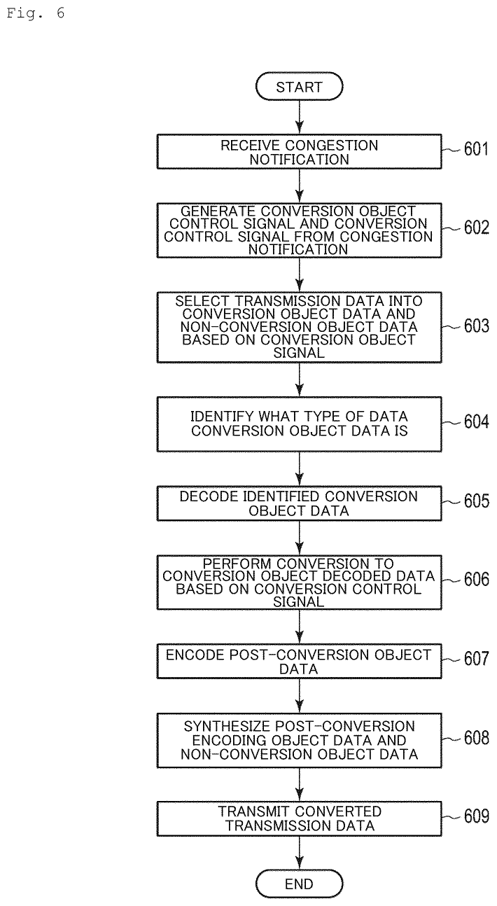

FIG. 6 is a flowchart showing an example of an operation of a transmission data conversion operation of the code conversion correspondence relay node 3. The operations shown in the flowchart are realized when the processor 301 of the code conversion correspondence relay node 3 reads and executes a program stored in the program memory 302. This flowchart is started when the congestion monitor unit 34 transmits a congestion notification to the congestion monitor type encoding control unit 33 since the reception queue 32 receives the transmission data from the reception unit 31 and the occupancy ratio of the capacity of the reception queue 32 for transmitting the transmission data to the congestion monitor type encoding control unit 33 exceeds a predetermined threshold value. That is, the congestion notification is transmitted when it is determined that smooth communication between users becomes difficult in the congestion monitor type encoding control unit 33.

The coding conversion judgement unit 335 of the congestion monitor type encoding control unit 33 receives the congestion notification from the congestion monitor unit 34 (601). The encoding conversion judgement unit 335 generates the conversion object control signal and the conversion control signal from the congestion notification (602). The conversion object control signal is a signal indicating which data is to be converted and which data is not to be converted among the transmission data in the conversion object data identification unit 331, and the conversion control signal is a signal including information indicating how much the transmission data is congested in the reception queue 32. Then, the encoding conversion judgement unit 335 transmits the conversion object control signal to the conversion object data identification unit 331, and transmits the conversion control signal to the conversion unit 334.

The conversion object data identification unit 331 selects the transmission data received from the reception queue 32 into conversion object data and non-conversion object data on the basis of the conversion object control signal received from the encoding conversion judgement unit 335 (603). Here, the conversion object data is data requiring conversion of a data type or reduction of a data amount by the conversion unit 334, and the non-conversion object data is data requiring no conversion of a data type by the conversion unit 334. For example, the conversion object data identification unit 331 judges whether conversion is possible for each stream in which the user equipment UE of the transmission source and the user equipment UE of the destination are frame strings of the same transmission data. Then, the conversion object data. identification unit 331 identifies a stream requiring conversion from the streams judged to be able to be converted on the basis of the conversion object control signal. The conversion object data identification unit 331 transmits the identified stream to the data type identification unit 332 as conversion object data, and transmits the unidentified stream to the transmission queue 35 as non-conversion object data.

The data type identification unit 332 identifies what data type the received conversion object data is (604). For example, the data type identification unit 332 identifies that the conversion object data is voice data. Then, the data type identification unit 332 transmits the identified conversion object data to the decoding unit 333. For example, the data type identification unit 332 transmits identification information indicating that the conversion object data and the non-conversion object data are the voice data.

The decoding unit 333 decodes the identified conversion object data (605). The decoding unit 333 identifies, for example, the conversion object data as the voice data on the basis of the identification information. Then, the decoding unit 373 decodes the conversion object data by using the voice decoding unit 3331 to generate the voice data. Then, the decoding unit 333 transmits the decoded voice data to the conversion unit. 334 as the conversion object decoding data.

The conversion unit 334 converts the conversion object decoded. data on the basis of the conversion object control signal received from the encoding conversion judgement unit 335 (606). The conversion unit 334 determines how to convert the conversion object decoded data on the basis of the conversion object control signal. For example, the conversion unit 334 judges how much the amount of data of the conversion object decoded data is to be reduced on the basis of the data type of the conversion object decoded data received from the decoding unit 333 and information on how much the transmission data indicated by the conversion control signal is congested. Then, the conversion unit 334 determines which of the voice→voice conversion unit 3341 or the like is used to convert the conversion object decoded data on the basis of the judgement. Then, the conversion unit 334 converts the identified conversion object decoded data by using one of the voice—voice conversion unit 3341 and the like. For example, the conversion unit 334 determines that the conversion object decoded data needs to be converted from voice data to character data on the basis of the data type of the conversion object decoded data and the conversion object control signal. Therefore, the conversion unit 334 converts the conversion object decoded data, which is the voice data, into the character data by using the voice→character conversion unit 3342. Then, the conversion unit 334 transmits post-conversion object decoded data which is the converted character data to the encoding unit 336. For example, the conversion unit 334 transmits information indicating that the post-conversion object decoded data is the character data together with the post-conversion object decoded data to the encoding unit 336. Here, when the conversion unit 334 compresses the conversion object decoded data by using the voice→voice conversion unit 3341, that is, when the conversion is performed with the same data type, the conversion unit 334 can transmit information indicating how compression has been performed to the encoding unit 336. When the encoding unit 336 receives the information, it is possible to decode the post-conversion object data so as to include the information.

Here, for example, the conversion unit 334 compresses the data by converting the post-conversion object decoded data into the same data type when a congestion degree indicating how much the transmission data indicated in the conversion control signal is congested is less than a predetermined threshold value, and may compress the data by converting the post-conversion object decoded data into different types of data when the congestion degree is equal to or greater than the predetermined threshold value. That is, when the transmission data indicated by the conversion control signal is not congested so much (when the congestion degree is lower than, the predetermined threshold value and the quality of the transmission data is not greatly deteriorated), the conversion unit 334 compresses the data by converting the transmission data into the same data type, and when the transmission data is congested (when the congestion degree is equal to or more than the predetermined threshold value and the quality of the transmission data is greatly deteriorated), the conversion unit 334 may compress the data by converting the transmission data into different types of data.

The encoding unit 336 encodes the post-conversion object decoded data (607). For example, the encoding unit 336 identifies that the post-conversion object decoded data is character data on the basis of the information. received from the conversion unit 334. Therefore, the encoding unit 336 encodes the post-conversion object decoded data by using the character encoding unit 3362. The encoded character data is transmitted to the transmission queue 35 as the post-conversion object data.

The transmission queue 35 synthesizes the received pose.-conversion object data with the non-conversion object data stored in the transmission queue 35 (608). The transmission queue 35 retrieves and extracts the non-conversion object data corresponding to the received post-conversion object data. Further, the transmission queue 35 synthesizes the post-conversion object data and the non-conversion object data. Then, the synthesized data is transmitted to the transmission unit 36 as converted transmission data. The converted transmission data is data obtained by converting the data type to data requiring conversion among the transmission data.

The transmission unit 36 transmits the converted transmission data to the other user equipment USE via the transmission line 4 (609). The user equipment UE decodes the received converted transmission data and displays the character data to the user. That is, although the user on the transmission-side transmits the voice data, the user on the reception-side receives the voice data as the character data. By converting the data type according to the congestion state of the transmission data, deterioration of the transmission data can be prevented, and smooth communication between users can be promoted.

### (Functions and Effects)

As described above, according to the first embodiment, the code conversion correspondence relay node 3 converts the transmission data transmitted from the transmission-side user equipment UE into an appropriate type of information or appropriately reduces the data capacity to transmit the information to the reception-side user equipment UE when the state of the transmission line is remarkably deteriorated. Thus, it is possible to avoid the situation in which the smooth communication is prevented, since the user equipment UE receiving the transmission data cannot listen to the voice and asks again or requests retransmission without viewing an image. Thus, even when the state of the transmission line 4 is remarkably deteriorated in the information communication system, information sufficient for smooth communication. between users can be transmitted from the transmission-side user equipment to the reception-side user equipment UE.

### Second Embodiment

### (Configuration)

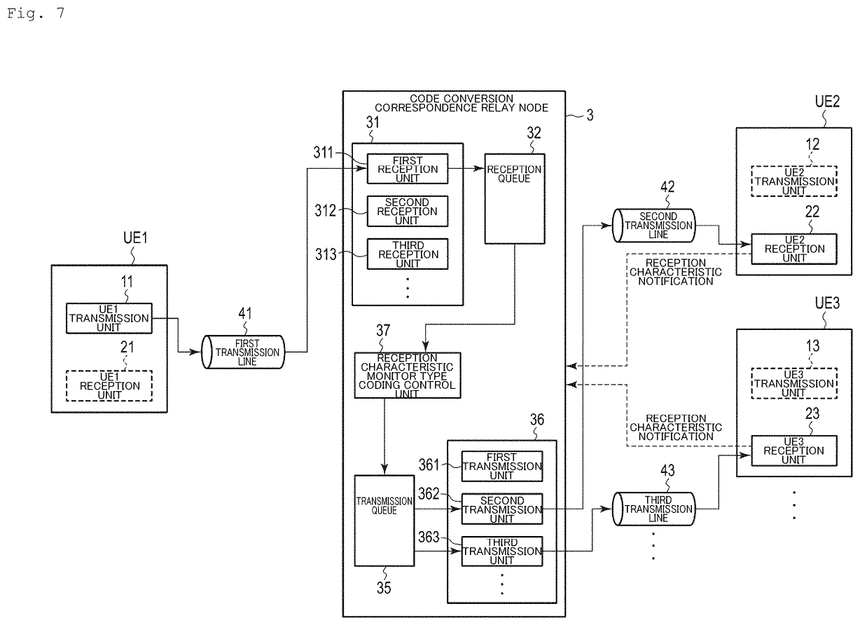

FIG. 7 is a block diagram showing an example of a schematic configuration of an information communication system according to a second embodiment of the present invention.

The code conversion correspondence relay node 3 of the second embodiment is different in that a reception characteristic monitor type encoding control unit 37 is provided instead of the congestion monitor type encoding control unit 33 and the congestion monitor unit 34. In the code conversion correspondence relay node 3 of the second embodiment, the reception unit 31 receives the reception characteristic notification. Then, the reception characteristic monitor type encoding control unit 37 receives the reception characteristic notification via the reception queue 32. Note that the reception characteristic notification will be described later. The reception characteristic monitor type encoding control unit 37 selects various information to be transmitted to a user of a user equipment UE on a reception-side included in transmission data received from the reception queue 32 into conversion object data and non-conversion object data. The reception characteristic monitor type encoding control unit 37 decodes the conversion object data to generate conversion object decoded data. For example, the reception characteristic monitor type encoding control unit 37 decodes the conversion object data to generate voice data as the conversion object decoded data. Further, the reception characteristic monitor type encoding control unit 37 converts the type of the conversion object decoded data into the post-conversion object decoded data on the basis of the reception characteristic notification received from the user equipment UE. For example, the reception characteristic monitor type encoding control unit 37 converts voice data into character data or image data, or converts the voice data into voice data whose information amount is reduced. Further, the reception characteristic monitor type encoding control unit 37 performs encoding corresponding to the post-conversion object decoded data to Generate the post-conversion object data. Then, the reception characteristic monitor type encoding control unit 37 transmits the post-conversion object data and the non-conversion object data to a transmission queue 35.

All other configurations of the second embodiment are similar to those of the first embodiment, and therefore detailed description thereof will be omitted.

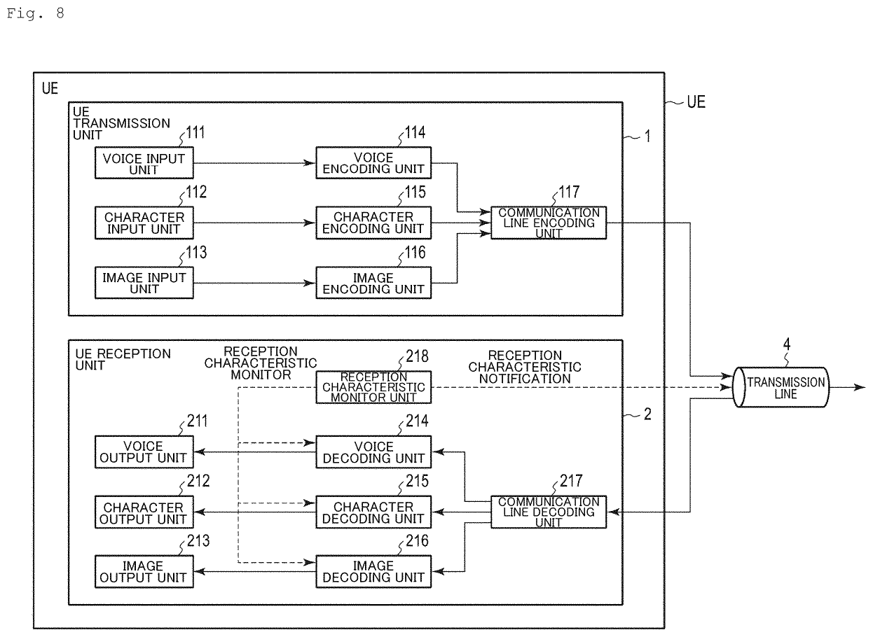

FIG. 8 is a diagram showing an example of a specific structure of the user equipment UE.

The user equipment UE of the second embodiment differs from that of the first embodiment in that the UE reception unit 2 includes a reception characteristic monitor unit 218.

The reception characteristic monitor unit 218 monitors reception characteristics of the UE reception unit 2. For example, various data decoded by the voice decoding unit 214, the character decoding unit 215, and the image decoding unit 216 are monitored and the reception characteristics are estimated. The reception characteristic may be a general index such as a reception delay, and a detailed description thereof will be omitted. When the reception characteristics are less than a predetermined threshold value, the reception characteristic monitor unit 218 transmits the reception characteristic notification to the code conversion correspondence relay node 3 via the transmission line 4.

All other configurations of the user equipment UE of the second embodiment are similar to those of the first embodiment, and therefore detailed description thereof will be omitted.

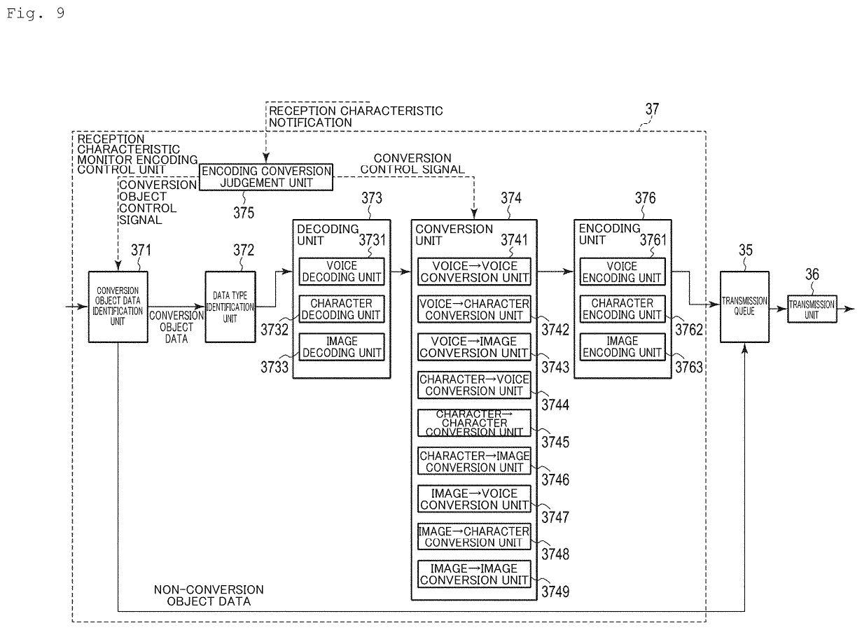

FIG. 9 is a diagram showing an example of a specific configuration of the reception characteristic monitor type encoding control unit 37 of the code conversion correspondence relay node 3.

The reception characteristic monitor type encoding control unit 37 of the second embodiment includes a conversion object data identification unit 371, a data type identification unit. 372, a decoding unit 373, a conversion unit 374, an encoding conversion judgement unit 375, and an encoding an it 376. In addition, the encoding unit 373 includes a voice decoding unit 3731, a character decoding unit 3732, an image decoding unit 3733. Further, the conversion unit 374 includes a voice→voice conversion unit 3741, a voice→character conversion unit 3742, a voice→image conversion unit 3743, a character→voice conversion unit 3744, a character→character conversion unit 3745, a character→image conversion unit 3746, an image→voice conversion unit 3747, an image→character conversion unit 3748, and an image→image conversion unit 3749.

The conversion object data identification unit 371, the data type identification unit 372, the decoding unit 373, the conversion unit 374, and the encoding unit 376 are the same configuration as the conversion object data identification unit 331, the data type identification unit 332, the decoding unit 333, the conversion unit 334, and the encoding unit 336 of the congestion monitor type encoding control unit 33 of the first embodiment, and detailed description thereof will be omitted. In addition, the voice decoding unit 3731, the character decoding unit 3732, and the image decoding unit 3733 are the same configuration as the voice decoding unit 3331, the character decoding unit 3332, and the image decoding unit 3333 of the first embodiment, respectively, and detailed description thereof will be omitted. Further, the voice→voice conversion unit 3741, the voice→character conversion unit 3742, the voice→image conversion unit 3743, the character→voice conversion unit 3744, the character→character conversion unit 3745, the character→image conversion unit 3746, the image→voice conversion unit 3747, the image→character conversion unit 3748, and the image→image conversion unit 3749 are the same configuration as the voice→voice conversion unit 3341, the voice→character conversion unit 3342, the voice→image conversion unit 3343, the character→voice conversion unit 3344, the character→character conversion unit 3345, the character→image conversion unit 3346, the image→voice conversion unit 3347, the image→character conversion unit 3348, and the image-image conversion unit 3349 of the first embodiment, respectively, and detailed description thereof will be omitted.

The encoding conversion judgement unit 375 receives the reception characteristic notification from the UE reception unit 2 of the user equipment UE on the reception-side. Then, the encoding conversion judgement unit 375 generates a conversion object control signal and a conversion control signal from the reception characteristic notification. The conversion object control signal is a signal indicating which data is to be converted and which data is not required to be converted among transmission data in the conversion object data identification unit 371, and the conversion control signal is a signal including information indicating how the reception characteristic estimated by the reception characteristic monitor unit 218 is. Then, the encoding conversion judgement unit 375 transmits the conversion object control signal to the conversion object data identification unit 371, and transmits the conversion control signal to the conversion unit 374.

### (Operation)

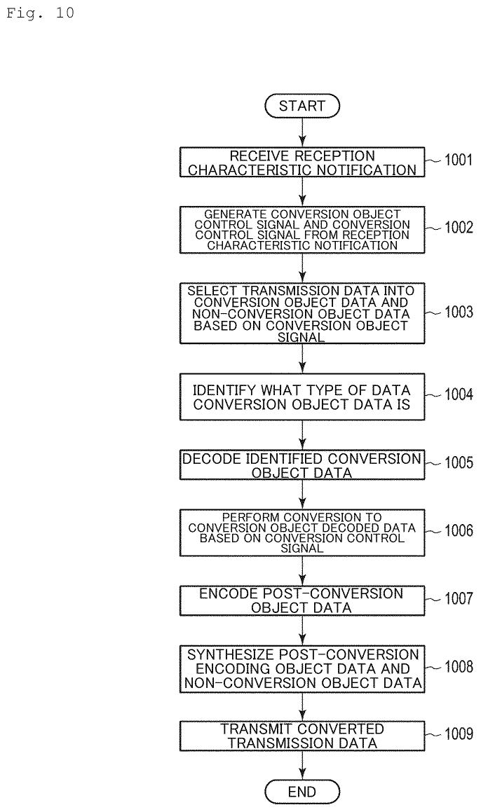

FIG. 10 is a flowchart showing an example of an operation of a transmission data conversion operation of the code conversion correspondence relay node 3. The operations shown in the flowchart are realized when the processor 301 of the code conversion correspondence relay node 3 reads and executes a program stored in the program memory 302. In addition, this flowchart is started when the reception queue 32 receives the transmission data from the reception unit 31 and the reception queue 32 transmits the transmission data to the congestion monitor type encoding control unit 33.

The encoding conversion judgement unit 375 of the congestion monitor type encoding control unit 33 receives the reception characteristic notification from the UE reception unit 2 of the user equipment UE on the reception-side (1001). The reception characteristic notification is transmitted from the reception characteristic monitor unit 218 when reception characteristics such as reception delay of the converted transmission data exceeds a predetermined threshold value in the user equipment UE on the reception-side. That is, the reception characteristics are transmitted when smooth communication between users becomes difficult.

The coding conversion judgement unit 375 generates the conversion object control signal and the conversion control signal from the reception characteristic notification (1002). The conversion object control signal is a signal indicating which data is to be converted and which data is not required to be converted among transmission data in the conversion object data identification unit 371, and the conversion control signal is a signal including information indicating how the reception characteristic estimated. by the reception characteristic monitor unit 218 is. Then, the encoding conversion judgement unit 375 transmits the conversion object control signal to the conversion object data identification unit 371, and transmits the conversion control signal to the conversion unit 374.

The conversion object data identification unit 371 selects the transmission data received from the reception queue 32 into conversion object data and non-conversion object data on the basis of the conversion object control signal received from the encoding conversion judgement unit 375 (1003). Here, the conversion object data is data requiring conversion of the data type or reduction of data capacity by the conversion unit 374, and the non-conversion object data is data not requiring conversion of the data type or reduction of data capacity by the conversion unit 374. For example, the conversion object data identification unit 371 determines whether or not conversion is possible for each stream in which the user equipment UE of the transmission source and the user equipment UE of the destination are frame strings of the same transmission data. Then, the conversion object data identification unit 371 identifies a stream requiring conversion from among the streams judged to be able to be converted on the basis of the conversion object control signal. The conversion object data identification unit 371 transmits the identified stream to the data type identification unit 372 as the conversion object data, and transmits the unidentified stream to the transmission queue 35 as the non-conversion object data.

The data type identification unit 372 identifies what data the received conversion object data is (1004). For example, the data type identification unit 372 identifies that the conversion object data is voice data. Then, the data type identification unit 372 transmits the identified conversion object data to the decoding unit 313. For example, the data type identification unit 372 transmits identification information indicating that the conversion object data and the non-conversion object data are voice data.

The decoding unit 373 decodes the identified conversion object data (1005). The decoding unit 373 identifies, for example, the conversion object data as the voice data on the basis of the identification information. Then, the decoding unit 373 decodes the conversion object data by using the voice decoding unit 3731 to generate the voice data. Then, the decoding unit 373 transmits the decoded voice data to the conversion unit 374 as the conversion object decoding data.

The conversion unit 374 converts the conversion object decoded data on the basis of the conversion object control signal received from the coding conversion judgement unit 375 (1006). The conversion unit 374 determines how to convert the conversion object decoded data on the basis of the conversion object control signal. For example, the conversion unit 374 judges how much the amount of data of the conversion object decoded data is to be reduced on the basis of the data type of the conversion object decoded data received from the decoding unit 333 and what value the reception characteristic signal indicated by the conversion control signal is. Then, the conversion unit 374 determines which of the voice→voice conversion unit 3741 or the like is used to convert the conversion object decoded data on the basis of the judgement. Then, the conversion unit 374 performs conversion to the identified conversion object decoded data by using one of the voice, voice conversion unit 3741 and the like. For example, the conversion unit 374 determines that the conversion object decoded data needs to be converted from voice data to character data on the basis of the data type of the conversion object decoded data and the conversion object control signal. Therefore, the conversion unit 374 converts the conversion object decoded data, which is the voice data, into the character data by using the voice→character conversion unit 3742. Then, the conversion unit 374 transmits the post-conversion object decoded data, which is the converted character data, to the encoding unit 336. For example, the conversion unit 374 transmits information indicating that the post-conversion object decoded data is the character data together with the post-conversion object decoded data to the encoding unit 336. When the conversion unit 374 compresses the data of the conversion object decoded data by using the voice→voice conversion unit 3741, that is, when the conversion unit 374 performs conversion with the same data type, the conversion unit 374 can transmit information indicating what compression has been performed to the encoding unit 376. When receiving the information, the encoding unit 376 can decode the post-conversion object data so as to include the information.

Here, for example, the conversion unit 374 compresses the data by converting the post-conversion object decoded data into the same data type when a congestion degree indicating how much the transmission data indicated in the conversion control signal is congested is less than a predetermined threshold value, and may compress the data by converting the post-conversion object decoded data into different types of data when the congestion degree is equal to or greater than the predetermined threshold value. That is, when the transmission data indicated by the conversion control signal is not congested so much (when the congestion degree is lower than the predetermined threshold value and the quality of the transmission data is not remarkably deteriorated), the conversion unit 374 compresses the data by converting the transmission data into the same data type, and when the transmission data is congested (when the congestion degree is equal to or more than the predetermined threshold value and the quality of the transmission data is greatly deteriorated), the conversion unit 374 may compress the data by converting the transmission data into different types of data.

The encoding unit 376 encodes the post-conversion object decoded data (1007). For example, the encoding unit 376 identifies that the post-conversion object decoded data is character data on the basis of the information received from the conversion unit 374. Therefore, the encoding unit 376 encodes the post-conversion object decoded data by using the character encoding unit 3762. The encoded character data is transmitted to the transmission queue 35 as the post-conversion object data.

The transmission queue 35 syntheses the received post-conversion object data with the non-conversion object data stored in the transmission queue 35 (1008). The transmission queue 35 retrieves and extracts the non-conversion object data corresponding to the received post-conversion object data. Further, the transmission queue 35 synthesizes the post-conversion object data and the non-conversion object data. Then, the synthesized data is transmitted to the transmission unit 36 as converted transmission data. The converted transmission data is data obtained by converting the data type to data requiring conversion among the transmission data.

The transmission unit 36 transmits the converted transmission data to the other user equipment UE via the transmission line 4 (1009). The user equipment UE decodes the received converted transmission data and displays the character data to the user. That is, although the user on the transmission-side transmits the voice data, the user on the reception-side receives the voice data as the character data. By converting the data type according to the congestion state of the transmission data, deterioration of the transmission data can be prevented, and smooth communication between users can be promoted.

### (Functions and Effects)

As described above, according to the second embodiment, the code conversion correspondence relay node 3 judges whether the state of the transmission line 4 is remarkably deteriorated or not based on the reception characteristic notification from the reception-side user equipment UE, converts the transmission data transmitted from the transmission-side user equipment UE into an appropriate type of information and transmits the information to the reception-side user equipment UE when the state of the transmission line 4 is remarkably deteriorated. Thus, it is possible to avoid the situation in which the smooth communication is prevented, since the user equipment UE receiving the transmission data cannot listen to the voice and asks again or requests retransmission without viewing an image. Thus, even when the state of the transmission line 4 is remarkably deteriorated in the information communication system, information sufficient for smooth communication between users can be transmitted from the transmission-side user equipment UE to the reception-side user equipment UE.

### (Modification Example of Second Embodiment)

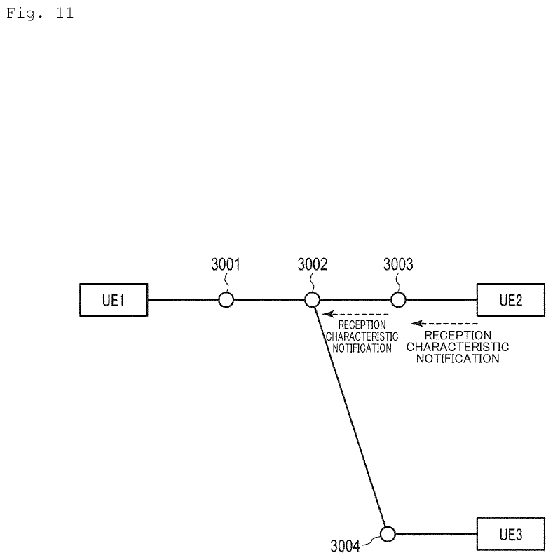

FIG. 11 is a block diagram showing an example of a schematic configuration of an information communication system according to a modification example of the second embodiment of the present invention.

In an information communication system shown in FIG. 11, there are a first code conversion correspondence relay node 3001, a second code conversion correspondence relay node 3002, a third code conversion correspondence relay node 3003, and a fourth code conversion correspondence relay node 3004. The first code conversion correspondence relay node 3001 at the high-order is connected to the first user equipment UE1 and is connected to the low-order second code conversion correspondence relay node 3002. Then, the second code conversion correspondence relay node 3002 is connected to the third code conversion correspondence relay node 3003 and the fourth code conversion correspondence relay node 3004 at the low-order. Then, the second user equipment UE2 is connected to the third code conversion correspondence relay node 3003 as a subordinate, and the third user equipment UE3 is connected to the fourth code conversion correspondence relay node 3004 as a subordinate. In the following description, the first code conversion correspondence relay node 3001, the second code conversion correspondence relay node 3002, the third code conversion correspondence relay node 3003 and the fourth code conversion correspondence relay node 3004 are not necessary to be distinguished, the node is simply referred to as the code conversion correspondence relay node 3.

As shown in FIG. 11, the third code conversion correspondence relay node 3003 can receive the reception characteristic notification from the subordinate second user equipment UE2 and transmit the reception characteristic notification to the second code conversion correspondence relay node 3002. In this case, it is necessary to determine which code conversion correspondence relay node 3 converts the type of transmission data or reduces the information amount. In the modification example of the second embodiment, it is determined that the transmission data is to be converted by the code conversion correspondence relay node 3 for receiving the reception characteristic notification from a part of a plurality of subordinate user equipment UE or the high-order code conversion correspondence relay node 3 of the code conversion correspondence relay node 3. For example, the code conversion correspondence relay node 3 transmits a reception. characteristic notification to the high-order side code conversion correspondence relay node 3 when there is one subordinate user equipment UE, and converts the transmission data about the transmission line 4 receiving the reception characteristic notification on the basis of the reception characteristic notification when there are n, which is two or more, subordinate user equipment UE and receiving the reception characteristics from the subordinate user equipment UE of n−1 or less in this case, the transmission data is converted in accordance with the transmission line 4 at the code conversion correspondence relay node 3 where a plurality of subordinate user equipment UE exist, so that only the transmission data to be transmitted through the transmission line 4 which is remarkably deteriorated can be converted. Further, when the number of subordinate user equipment UE is n and reception characteristic notifications are received from all the n subordinate user equipment, the reception characteristic notifications are transmitted to the high-order side code conversion correspondence relay node 3 in this case, the high-order side code conversion correspondence relay node 3 receiving the reception characteristic notification converts the transmission data on the basis of the reception characteristic notification. Since all the transmission lines 4 connected to the subordinate user equipment UE are remarkably deteriorated, this makes one conversion at the high-order side code conversion correspondence relay node 3. Note that when the high-order side code conversion correspondence relay node 3 does not exist, the code conversion correspondence relay node 3 which has received the reception characteristic notification converts the transmission data. Therefore, in the modification example of the second embodiment, when receiving the reception. characteristic notification from all the subordinate user equipment UE, the reception characteristic is notified to the high-order side code conversion correspondence relay node 3. On the other hand, when receiving the reception characteristic notification from a part of the subordinate equipment UE or the code conversion correspondence relay node 3 is the highest order code conversion correspondence relay node 3, the transmission data is collectively converted only once. Thus, efficient conversion can be performed as a whole of the information communication system, and efficient communication can be performed.

Further, the code conversion correspondence relay node 3 determined to convert the transmission data receives a plurality of reception characteristic notifications. Then, since the plurality of reception characteristic notifications have different communication quality depending on the path, the plurality of reception characteristic notifications becomes different. Therefore, the code conversion correspondence relay node 3 can change the conversion technique of the transmission data for each received reception characteristic notification. For example, the code conversion correspondence relay node 3 for converting transmission data can group the user equipment UE on the reception-side into a certain group, and the conversion technique can be changed in accordance with the reception characteristic notification from the group.

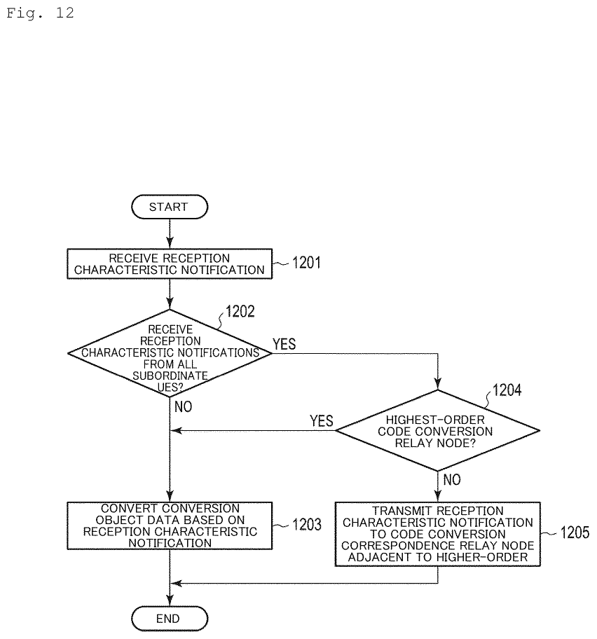

FIG. 12 is a flowchart showing an example of a transmission data conversion place determination operation of the code conversion correspondence relay node 3. The operations shown in the flowchart are realized when the processor 301 of the code conversion correspondence relay node 3 reads and executes a program stored in the program memory 302. The flowchart is started when the user equipment UE on the reception-side transmits the reception characteristic notification. The code conversion correspondence relay node 3 receives the reception characteristic notification (1201). The reception characteristic notification is received from the reception-side user equipment UE or the code conversion correspondence relay node 3 connected as the subordinate. The reception characteristic notification is transmitted from the reception characteristic monitor unit 218 when reception characteristics such as reception delay of the converted transmission data exceeds a predetermined threshold value in the reception-side user equipment UE.

The code conversion correspondence relay node 3 judges whether or not the reception characteristic notification has been received from all the subordinate user equipment UE (1202). When it is judged that the reception characteristic notification has been received from a part of the subordinate user equipment UE, the code conversion correspondence relay node 3 judges that conversion object data in the transmission data need to be converted. Then, the processing proceeds to 1203. On the other hand, when receiving the reception. characteristic notification from all the subordinate user equipment UE, the processing proceeds to 1204.

When it is judged that the reception characteristic notification is received from a part of the subordinate user equipment UE, the code conversion correspondence relay node 3 converts conversion object data in the data transmission on the basis of each of the received reception characteristic notification (1203). Note that since the conversion method is the method described in the second embodiment, detailed description thereof will be omitted.

When it is judged that the reception characteristic notification has been received from all the subordinate user equipment UE, the code conversion correspondence relay node 3 judges whether or not the code conversion correspondence relay node 3 is the highest-order code conversion correspondence relay node 3 (1204). When it is judged that the code conversion correspondence relay node 3 does not exist on the high-order side, that is, the code conversion correspondence relay node 3 is the highest-order code conversion correspondence relay node 3, the code conversion correspondence relay node 3 needs to convert the conversion object data. Therefore, the processing proceeds to 1203. Then, as described above, the code conversion correspondence relay node 3 converts the conversion object data in the data transmission based on each of the received reception characteristic notifications. On the other hand, when the code conversion correspondence relay node 3 exists on the high-order side of the code conversion correspondence relay node 3, the processing proceeds to 1204. In addition, the judgement of 1202 and 1204 can be replaced. That is, the code conversion correspondence relay node 3 may determine whether or not the reception characteristic notification has been received from all the subordinate user equipment UE when it is judged that the highest-order code conversion correspondence relay node 3 exists.

When it is judged that there is a code conversion. correspondence relay adjacent to the higher-order, the code conversion correspondence relay node 3 transmits the received reception characteristic not to the code conversion correspondence relay node 3 adjacent to the higher-order (1205). That is, the code conversion correspondence relay node 3 does not convert the conversion object data and the high-order side code conversion correspondence relay node 3 converts the conversion object data.

### (Functions and Effects)

In one-to-many data transmission in which one user equipment UE or one code conversion correspondence relay node 3 transmits transmission data and a plurality of code conversion correspondence relay nodes 3 or a plurality of user equipment UE receives the transmission data, when an encoding method is changed in a transmission source user equipment or code conversion correspondence relay node 3, the quality of the code conversion correspondence relay node 3 whose transmission line 4 is not deteriorated and information transmitted to the user equipment UE is deteriorated. On the other hand, according to the modification example of the second embodiment as described above, only the transmission data to be transmitted to the transmission line 4 which has received the reception characteristic notification is converted by the code conversion correspondence relay node 3 which can receive the plurality of reception characteristic notifications, that is, the plurality of code conversion correspondence relay nodes 3 or the code conversion correspondence relay node 3 connected to the user equipment UE. Thus, the code conversion correspondence relay node 3 can perform conversion processing only to the transmission data transmitted through the transmission line 4 which is remarkably deteriorated, and the deterioration of information quality of the transmission data transmitted to the user equipment whose transmission line 4 is not deteriorated can be prevented.

### Other Embodiments

Note that the present invention is not limited to the above embodiments. For example, the present invention can be applied to the case where congestion does not occur or the communication quality does not deteriorate. For example, when the transmission data is voice data, the code conversion correspondence relay node 3 converts the voice data into voice data and also converts the voice data into character data. Thus, the reception-side user equipment UE can receive the character data together with the voice data, and can promote smooth communication between users.

Additionally, the techniques described in the embodiments can also be distributed as a program (software means) that can be executed by a computing device (a computer), which is stored in a recording medium such as a magnetic disk (a Floppy (registered trademark) disk, a hard disk, or the like), an optical disk (a CD-ROM, a DVD, an MO, or the like), an semiconductor memory (a ROM, a RAM, a Flash memory, or the like), or which is transmitted by a communication medium. Note that, the program stored on the media side also includes a configuration program that configures, in the computer, the software means (including not only an executable program but also tables and data structures) to be executed by the computer. The computer that realizes this device reads the program recorded on the recording medium, and in some cases constructs software means by the configuration program, and executes the above-described processing by being controlled by this software means. Note that the recording medium referred to in the present specification is not limited to being for distribution, and includes storage media such as a magnetic disk or a semiconductor memory provided in a computer or in a device connected via a network.

In other words, this invention is not limited to the above embodiments, and can be modified in various ways without departing from the scope thereof at the implementation stage. Also, the embodiments may be combined, if possible, as appropriate to obtain combined effects. Furthermore, the above-described embodiments include inventions in various stages, and various inventions are extracted through appropriate combinations of a plurality of disclosed constituent elements.

### REFERENCE SIGNS LIST

1 UE transmission unit

11, 12, 13 User equipment transmission unit

101, 301 Processor

102, 302 Program memory

103, 303 Data memory

104, 304 Communication interface

105, 305 Input/output interface

106, 306 Bus

107 Input unit

108 Display unit

111 Voice input unit

112 Character input unit

113 Image input unit

114, 3361, 3761 Voice encoding unit

115, 3362, 3762 Character encoding unit

116, 3363, 3763 Image encoding unit

117 Communication line encoding unit

2 UE reception unit

21, 21, 23 User equipment reception unit

211 Voice output unit

212 Character output unit

213 Image output unit

214, 3331, 3731 Voice decoding unit

215, 3332, 3732 Character decoding unit

216, 3333, 3733 Image decoding unit

217 Communication line decoding unit

218 Reception characteristic monitor unit

3 Code conversion correspondence relay node

31, 311, 312, 313 Reception unit

32 Reception queue

33 Congestion monitor type encoding control unit

34 Congestion monitor unit

35 Transmission Queue

36 Transmission unit

37 Reception characteristic monitor type encoding control unit

331, 371 Conversion object data identification unit

332, 372 Data type identification unit

333, 373 Decoding unit

334, 374 Conversion unit

335, 375 Coding conversion judgement unit

336, 376 Encoding unit

361, 362, 363 Transmission unit

3001, 3002, 3003, 3004 Code conversion correspondence relay node

3341, 3741 voice→voice conversion unit

3342, 3742 Voice→character conversion unit

3343, 3743 Voice→image conversion unit

3344, 3744 Character→voice conversion unit

3345, 3745 Character→character conversion unit

3346, 3746 Character→image conversion unit

3347, 3747 Image→voice conversion unit

3348, 3748 Image character conversion unit

3349, 3749 Image-image conversion unit

4, 41, 42, 43 Transmission line

UE1, UE2, UE3 User equipment

1. An information communication device for connection between a transmission-side device and a reception-side device, comprising:
a receiver to receive transmission data to be transmitted from the transmission-side device to the reception-side device;
control circuitry configured to receive a notification indicating deterioration in quality of the transmission data, determine conversion object data for converting a data type of the transmission data or reducing an information amount of the transmission data and non-conversion object data for not converting a data type based on the notification, and generate post-conversion object data by converting a type of the conversion object data based on the notification;
a transmission queue to synthesize the non-conversion object data and the post-conversion object data and generate converted transmission data; and
a transmitter to transmit the converted transmission data to the reception-side device.

2. The information communication device according to claim 1, further comprising:
congestion monitor circuitry configured to monitor a congestion rate of the transmission data in the information communication device, and transmit a congestion notification as the notification to the control circuitry when the congestion rate exceeds a predetermined threshold value.

3. The information communication device according to claim 1, wherein:
the notification is a reception characteristic notification transmitted by a user equipment that receives the converted transmission data when a reception characteristic of the converted transmission data is lower than a predetermined threshold value.

4. The information communication device according to claim 3, wherein:
when receiving the reception characteristic notifications from all the user equipment that receive the converted transmission data transmitted from the information communication device, the control circuitry transmits the reception characteristic notification to the other information communication device that has transmitted the transmission data to the information communication device, and
when receiving the reception characteristic notification from at least one of the user equipment that is not all the user equipment that receive the converted transmission data transmitted from the information communication device or the other information communication device that has transmitted the transmission data to the information communication device does not exist, the control circuitry converts the data type of the transmission data to be transmitted to the at least one user equipment that has transmitted the reception characteristic notification or reduce the information amount of the transmission data.

5. The information communication device according to claim 1, wherein the control circuitry comprises:
a decoder to perform decoding corresponding to the conversion object data;
conversion circuitry configured to convert the decoded conversion object data into a predetermined type data or reduces a data capacity of the decoded conversion object data; and
an encoder to perform encoding corresponding to the converted or reduced data.

6. The information communication device according to claim 1, wherein:
the control circuitry converts the conversion object data into the same data as the data type of the conversion object data when a degree indicating deterioration in quality of the transmission data is less than a predetermined threshold value, and converts the conversion object data into a type different from the data type of the conversion object data when the degree is equal to or more than the predetermined threshold value.

7. An information communication method, comprising:
receiving transmission data to be transmitted;
receiving a notification indicating deterioration in quality of the transmission data;
determining conversion object data for converting a data type of the transmission data or reducing an information amount of the transmission data and non-conversion object data for not converting a data type based on the notification;
converting a type of the conversion object data on the basis of the notification to generate post-conversion object data;
generating converted transmission data by synthesizing the non-conversion object data and the post-conversion object data; and
transmitting the converted transmission data.

8. A non-transitory computer readable medium storing an information communication program for causing a processor to function as the information communication device according to claim 1.

9. A non-transitory computer readable medium storing an information communication program for causing a processor to execute the steps of claim 7.
